(19) United States
(12) Patent Application Publication
(10) Pub. No.: US 2025/0005879 A1
(43) Pub. Date: Jan. 2, 2025

(54) METHOD FOR OBJECT DETECTION, IMAGE DETECTION DEVICE, COMPUTER PROGRAM AND STORAGE UNIT

(71) Applicant: Robert Bosch GmbH, Stuttgart (DE)

(72) Inventors: Claudius Glaeser, Ditzingen (DE); Daniel Niederloehner, Stuttgart (DE); Daniel Koehler, Leonberg (DE); Florian Faion, Staufen (DE); Karim Adel Dawood Armanious, Stuttgart (DE); Maurice Quach, Ditzingen (DE); Michael Ulrich, Stuttgart (DE); Patrick Ziegler, Waiblingen (DE); Ruediger Jordan, Stuttgart (DE); Sascha Braun, Eningen Unter Achalm (DE)

(21) Appl. No.: 18/688,737

(22) PCT Filed: Dec. 28, 2022
(86) PCT No.: PCT/EP2022/087940

§ 371 Date: Mar. 1, 2024

(30) Foreign Application Priority Data
Feb. 2, 2022 (DE) 10 2022 201 073.6

(51) Int. Cl. G06V 10/25; G06V 10/44; G06V 10/82

(52) U.S. Cl. CPC G06V 10/25; G06V 10/44; G06V 10/82; G06V 2201/07

(57) ABSTRACT

A method for object detection of an object based on measurement data from at least one point-based sensor capturing the object. The measurement data, which are based on a point cloud having a plurality of points and associated features, are processed in that, in a point-based first processing step having at least one processing level, the input-side features of the point cloud are realized as learned features, and are enriched at least by information about relationships between the points, and in a grid-based second processing step having at least one processing level, the learned features are then transferred onto a model grid having a plurality of grid cells, and cell-related output data are then generated. An image detection device, a computer program, and a storage unit, are also described.

### FIELD

The present invention relates to a method for object detection. The present invention also relates to an image detection device, a computer program, and a storage unit.

### BACKGROUND INFORMATION

German Patent Application No. DE 10 2020 206 990 A1 describes a method for processing measurement data from sensors, which transfers the measurement data from a first sensor in a first encoder and the measurement data from a second sensor in a second encoder into a respective latent space. From the features in the latent space, a first decoder derives reconstructed measurement data from the first sensor and a second decoder derives reconstructed measurement data from the second sensor.

### SUMMARY

According to the present invention, a method for object detection is provided. A relationship between the points can thereby be captured more precisely and more reliably and can be better taken into account during processing. The feature context of the points can be better taken into account. Loss of information during processing can be reduced and detection performance can increase.

The object can be a vehicle, a living being, in particular a person, a building, and/or an item.

According to an example embodiment of the present invention, the object detection can include detection of at least one object property (object regression), object classification, and/or detection of an object movement path (object tracking).

The point-based sensor can output the measurement data in the form of at least one point cloud. The measurement data can be provided by at least two such sensors. The point-based sensor can be a camera, in particular a stereo camera or a mono camera, preferably with depth information and/or the application of image-processing algorithms, a time-of-flight camera, a lidar sensor, an ultrasonic sensor, a microphone, or a radar sensor. According to an example embodiment of the present invention, the first processing step can convert the input-side features into the learned features over several processing levels. The first processing step can apply PointNet, Pointnet++, graph neural network, continuous convolutions, kernel point convolutions, or other neural networks which have a point cloud as the input and output.

According to an example embodiment of the present invention, the second processing step can transfer the learned features onto a two-dimensional model grid, for example on the basis of a bird's eye view (BEV). If only one point of the point cloud lies in a grid cell, the learned features of the point can form the features of the grid cell. If a plurality of points of the point cloud lie in a grid cell, the learned features of these points of the grid cell can be combined as features of the grid cell. This combination can take place by applying a pooling algorithm or a PointNet.

The model grid can be defined by a prespecified grid resolution. The higher the grid resolution, the more grid cells there will be per unit of space or area. The lower the grid resolution, the higher the probability of detection of the object will be. The higher the grid resolution, the more precisely the object can be identified.

In a preferred example embodiment of the present invention, it is advantageous if the input-side features are included in an input-side feature vector associated with the individual point and the learned features are included in a latent feature vector associated with this point. The input-side features can be transferred to the first processing step in an unordered manner and independently of their sequence.

A preferred example embodiment of the present invention in which the input-side feature vector has a different dimension compared to the latent feature vector is advantageous. The latent feature vector can have a higher or lower dimension than the input-side feature vector.

In a preferred example embodiment of the present invention, it is advantageous if the input-side features of the individual point comprise information about its spatial position, its properties, and/or its adjacent points. The spatial position can be described by coordinates in a three-dimensional coordinate system. The properties can be a backscatter-signal intensity or input intensity, a reflection cross-section, an elevation angle and/or a radial velocity. The information about its adjacent points can include a number of adjacent points within a prespecified radius.

In a preferred example embodiment of the present invention, it is provided that the first processing step applies a trained artificial neural network. Learning can be implemented as multilayer learning (deep learning). The processing level can be an intermediate layer (hidden layer) in the artificial neural network.

The second processing step can apply a trained artificial neural network. The learned features from the first processing step can be reused in the second processing step. Training of the network in the second processing step can be dependent on or independent of training of the network in the first processing step.

A preferred example embodiment of the present invention is advantageous in which object-related output data for calculating an oriented bounding box of the object are formed from the cell-related output data via at least one further processing step. The oriented bounding box can be an oriented cuboid bounding box. The oriented bounding box can have at least one box parameter associated with the object. The box parameter can be a pose, at least one dimension, an object type class, and/or a probability of existence. An association with an object can be characterized via the object type class.

The oriented bounding box can be characterized more precisely with the point-based first processing step. The downstream grid-related second processing step allows an improvement in the probability of detection of the object and a lower error detection rate.

The object-related output data can comprise a list of object hypotheses. Object properties, in particular an object type class and the oriented bounding box, can be calculated for each object hypothesis.

The box parameters of the oriented bounding box can be calculated on the basis of the features of the grid cell. Furthermore, an image detection device having at least one point-based sensor providing measurement data about an object and a processing unit configured to carry out the method with at least one of the aforementioned features is provided according to the present invention. The computing power of the processing unit can thereby be reduced and the image detection device can be designed more cost-effectively.

In a preferred example embodiment of the present invention, it is advantageous if the point-based sensor is configured to output at least one point cloud as measurement data. The point-based sensor can be a camera, in particular a stereo camera or a mono camera, preferably with application of image-processing algorithms, a time-of-flight camera, a lidar sensor, an ultrasonic sensor, a microphone, or a radar sensor.

According to an example embodiment of the present invention, the image detection device can be associated with a driver assistance system and/or with an autonomous or semi-autonomous vehicle. The image detection device can be associated with a robot, in particular a robotic mower, an environment monitoring system, in particular a traffic monitoring system, or with a vehicle, in particular a motor vehicle, a truck or a two-wheeled vehicle, preferably a bicycle.

According to an example embodiment of the present invention, the image detection device can be used in an automated assembly plant, for example for detecting components and their orientation in order to determine the grip point. The image detection device can be used in automated lawnmowers, for example for detecting objects, in particular obstacles. The image detection device can be used in automatic access controls, for example for person detection and person identification for automatic door opening. The image detection devices can be used in an environment monitoring system, preferably for monitoring open spaces or buildings, for example for detecting, checking and classifying dangerous goods. The image detection device can be used in a traffic monitoring system, in particular with a stationary radar sensor system. The image detection device can be used in a driver assistance system for detecting and classifying road users, for example on a bicycle or another two-wheeler.

Furthermore, a computer program which has machine-readable instructions executable on at least one computer is provided according to the present invention, in the execution of which the method with at least one of the previously specified features is carried out. Furthermore, a storage unit is provided according to the present invention, which is designed to be machine-readable and accessible by at least one computer and on which the aforementioned computer program is stored.

Further advantages and advantageous embodiments of the present invention can be found in the description of the figures and in the figures.

### BRIEF DESCRIPTION OF THE DRAWINGS

The present invention is described in detail below with reference to the figures.

FIG. 1 shows an exemplary block diagram of a method for object detection in an example embodiment of the present invention.

FIG. 2 shows a structure of a graph convolution of an artificial neural network during the first processing step, according to an example embodiment of the present invention.

FIGS. 3A-3F show image detection devices in specific example embodiments of the present invention.

### DETAILED DESCRIPTION OF EXAMPLE EMBODIMENTS

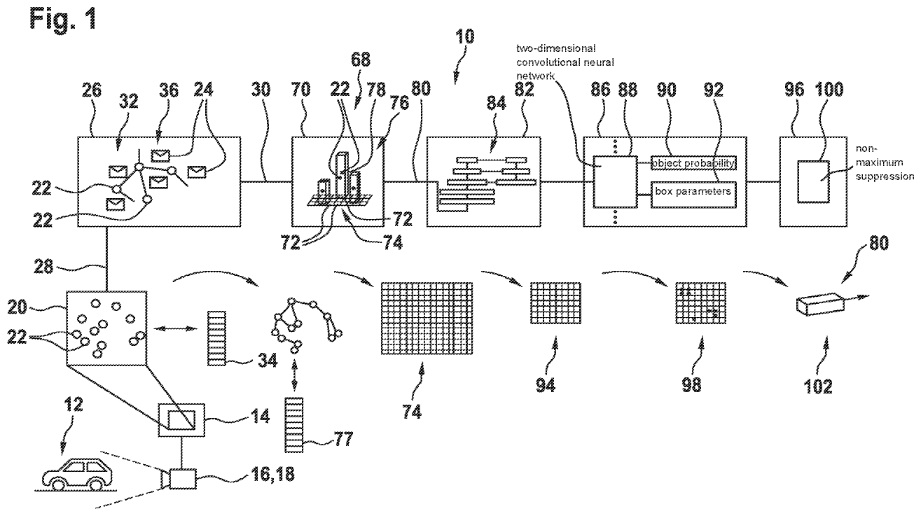

FIG. 1 shows an exemplary block diagram of a method for object detection in a special embodiment of the present invention. The method 10 for object detection of an object 12 uses measurement data 14 from at least of one point-based sensor 16 which captures the object 12. The sensor can be a radar sensor 18. The measurement data 14 comprise a point cloud 20 with a plurality of points 22 and associated features 24. In a first processing step 26, the features 24, as input-side features 28 of the point cloud 20, are realized as learned features 30. The first processing step 26 comprises at least one processing level 32.

The first processing step 26 is point-based. The input-side features 28 of the individual point 22 can comprise information about its spatial position, its properties and/or the adjacent points 22 thereof, and can be realized as an input-side feature vector 34. The spatial position can be described by coordinates in a three-dimensional coordinate system. The properties can be a backscatter-signal intensity or input intensity, a reflection cross-section, an elevation angle and/or a radial velocity. The information about its adjacent points 22 can include a number of adjacent points 22 within a prespecified radius. The input-side features 28 can be converted in the first processing step 26 in an unordered manner and independently of their sequence.

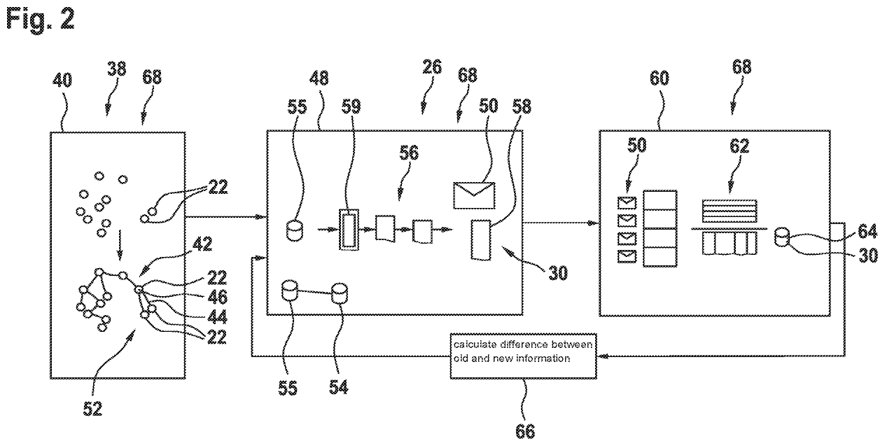

The processing level 32 can apply a trained artificial neural network 36, here, for example, a graph neural network 38, which is illustrated by way of example in FIG. 2 and is explained in more detail below. In a first step 40, said network constructs a graph 42 on the basis of the points 22, whereby points 22 which are located within a prespecified distance, for example three meters, are connected by edges 44. The points 22 represent the nodes 46 of the graph 42. In a second step 48, messages 50 are formed for all edges 44 of the graph 42, which messages consist of the relative positions 52 of the nodes 46 of an edge 44 in relation to each other and of the neighbor features 54 of the neighbors of the original node 55. As a result, the learned features 30 comprise information about relationships between the points 22. These messages 50 are processed by a multilayer perceptron 56 in order to extract new features 58. Here, the layers of the multilayer perceptron 56 in each case share the parameters 59 for all messages 50.

In a third step 60, features 64 calculated from the generated messages 50 are extracted by a maximum pooling 62 as the learned features 30 for the original node 55. In a calculation step 66, the difference between the old and the new information is then calculated (skip connection) and in the second step 48 is reattached to the nodes 46 or the points 22 as new information.

A plurality of processing levels 68 can be run through in the first processing step 26. PointNet, PointNet++, continuous convolutions, kernel point convolutions or other neural networks which have a point cloud as an input and output can also be applied instead of the graph neural network 38.

Returning to FIG. 1, in a grid-based second processing step 70 having at least one processing level 68, the learned features 30 are transferred onto a model grid 74 having a plurality of grid cells 72. A pillar feature network 76 is used to project the learned features 30 compiled in a latent feature vector 77 into the in this case two-dimensional model grid 74. For this purpose, all points 22 which are located in a grid cell 72 are combined into pillars 78. The learned features 30 of each point 22 are individually embedded by a fully connected neural network. In the event of a plurality of points 22 falling into the same pillar 78, a mean pooling is applied over all points 22 within the pillar 78 in order to obtain a feature vector with a fixed length. Instead of the pillar feature network 76, a different method can also be used in order to transfer feature vectors of points into a model grid 74, for example a direct assignment of the points to the grid cells 72 and a subsequent combination of all feature vectors which fall into the same grid cell 72, for example via mean pooling, max pooling or an attention mechanism.

These features can then be further processed as cell-related output data 80 via a third processing step 82, in particular with a two-dimensional convolutional neural network 84, which serves as a backbone. For example, a backbone consisting of a residual network and a feature pyramid network is used, which extracts features for different resolutions of the two-dimensional model grid 74.

In a fourth processing step 86, an object probability 90 between 0 and 1 and box parameters 92 for an oriented bounding box of the object 12, in particular a position, length, width, height and/or orientation, are estimated by class heads for each grid cell 72 via a further two-dimensional convolutional neural network 88. A plurality of these class heads can be used to detect different object types, and these class heads are in each case responsible for estimating an object type class, which means object types with similar properties such as trucks and buses. These class heads use feature maps 94 with the appropriate resolution according to the object types to be detected. For example, for small objects such as pedestrians, a feature map 94 is used with higher resolution than for large objects such as trucks.

Since an object can span a plurality of grid cells 72, the object hypotheses 98 generated in the fourth processing step 86 are filtered in a fifth processing step 96. This takes place in particular by a non-maximum suppression 100 (NMS). Here, for each object, from spatially overlapping object hypotheses 98 filtering is carried out according to the one with the highest object probability. The filtered object hypotheses in the form of an oriented bounding box 102 form the object-related output data 80 of the method 10.

The object-related output data 80 are, for example, a list of object hypotheses. For each object hypothesis, an object property, in particular an object type classification, an object position and box parameters, in particular a length, width, height and/or orientation of the oriented bounding box 102 which encloses the object can be calculated.

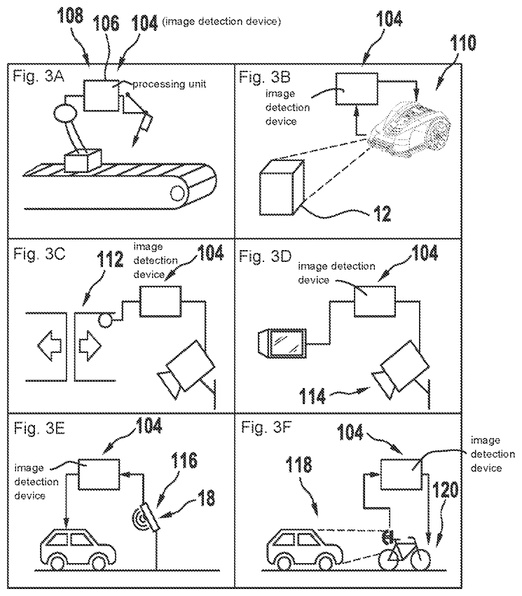

FIGS. 3A-3F show image detection devices in example embodiments of the present invention. FIG. 3A shows an image detection device 104 which comprises a processing unit 106 which carries out the method for object detection. The image detection device 104 can be used in an automated assembly plant 108, for example for detecting components and their orientation in order to determine the grip point. The image detection device 104 in FIG. 3B can be used in automated lawnmowers 110, for example for detecting objects 12, in particular obstacles. The image detection device 104 in FIG. 3C can be used in automatic access controls, for example for person detection and person identification for automatic door opening. The image detection device 104 in FIG. 3D can be used in an environment monitoring system 114, preferably for monitoring open spaces or buildings, for example for detecting, checking and classifying dangerous goods. The image detection device 104 in FIG. 3E can be used in a traffic monitoring system 116, in particular with at least one stationary radar sensor 18. The image detection device 104 in FIG. 3F can be used in a driver assistance system 118 for detecting and classifying road users, for example on a bicycle 120 or another two-wheeler.

1-10. (canceled)

11. A method for object detection of an object based on measurement data from at least one point-based sensor capturing the object, the method comprising the following:
processing the measurement data, which are based on a point cloud having a plurality of points and associated features, including:
in a point-based first processing step having at least one processing level, realizing input-side features of the point cloud as learned features and enriching the input-side features at least by information about relationships between the points; and
in a grid-based second processing step having at least one processing level, transferring the learned features onto a model grid having a plurality of grid cells, and generating cell-related output data.

12. The method for object detection according to claim 11, wherein the input-side features are included in an input-side feature vector associated with an individual point and the learned features are included in a latent feature vector associated with the individual point.

13. The method for object detection according to claim 12, wherein the input-side feature vector has a different dimension compared to the latent feature vector.

14. The method for object detection according to claim 12, wherein the input-side features of the individual point include information about a spatial position of the individual point and/or properties of the individual point and/or adjacent points of the individual point.

15. The method for object detection according to claim 11, wherein the first processing step applies a trained artificial neural network.

16. The method for object detection according to claim 11, wherein object-related output data for calculating an oriented bounding box of the object are formed from the cell-related output data via at least one further processing step.

17. An image detection device, comprising:
at least one point-based sensor configured to provide measurement data about an object; and
a processing unit for object detection of the object based the measurement data, the processing unit configured to:
process the measurement data, which are based on a point cloud having a plurality of points and associated features, including:
in a point-based first processing step having at least one processing level, realize input-side features of the point cloud as learned features and enrich the input-side features at least by information about relationships between the points; and
in a grid-based second processing step having at least one processing level, transfer the learned features onto a model grid having a plurality of grid cells, and generate cell-related output data.

18. The image detection device according to claim 17, wherein the point-based sensor is configured to output at least one point cloud as measurement data.

19. A non-transitory machine-readable storage unit on which is stored a computer program for object detection of an object based on measurement data from at least one point-based sensor capturing the object, the computer program, when executed by at least one computer, causing the at least one computer to perform the following:
processing the measurement data, which are based on a point cloud having a plurality of points and associated features, including:
in a point-based first processing step having at least one processing level, realizing input-side features of the point cloud as learned features and enriching the input-side features at least by information about relationships between the points; and
in a grid-based second processing step having at least one processing level, transferring the learned features onto a model grid having a plurality of grid cells, and generating cell-related output data.
